(19) United States
(12) Patent Application Publication
(10) Pub. No.: US 2024/0098644 A1
(43) Pub. Date: Mar. 21, 2024

(54) REPORTING AND TRIGGERING FOR LOW-POWER WAKE-UP SIGNAL MONITORING

(71) Applicant: Apple Inc., Cupertino, CA (US)

(72) Inventors: Sigen Ye, Whitehouse Station, NJ (US); Seyed Ali Akbar Fakoorian, San Diego, CA (US); Wei Zeng, Saratoga, CA (US); Ankit Bhamri, Bad Nauheim (DE); Dawei Zhang, Saratoga, CA (US); Hong He, San Jose, CA (US); Chunxuan Ye, San Diego, CA (US); Weidong Yang, San Diego, CA (US); Huaning Niu, San Jose, CA (US); Chunhai Yao, Beijing (CN); Oghenekome Oteri, San Diego, CA (US)

(73) Assignee: Apple Inc., Cupertino, CA (US)

(21) Appl. No.: 18/218,497

(22) Filed: Jul. 5, 2023

Related U.S. Application Data
(60) Provisional application No. 63/408,052, filed on Sep. 19, 2022.

(51) Int. Cl. H04W 52/02; H04W 76/20

(52) U.S. Cl. CPC H04W 52/0235; H04W 76/20

(57) ABSTRACT

Techniques are provided for Wake up signal monitoring in a radio resource control connected (RRC) mode. An example method can include a user equipment (UE) determining capability information associated with wake-up signal (WUS) monitoring, the capability information to include an indication that the UE supports WUS monitoring in a radio resource control (RRC) connected mode. The UE can transmit, to a base station, an indication of the capability. The UE can perform, while in a sleep state in which transmitting and receiving by a main radio is suspended, WUS monitoring to detect a trigger. The UE can transition from the sleep state to the awake state based on the trigger. The UE can monitor for a downlink (DL) transmission in the awake state.

### CROSS-REFERENCE TO RELATED APPLICATIONS

This application claims the benefit of U.S. Provisional Application No. 63/408,052, filed on Sep. 19, 2022, which is incorporated by reference.

### BACKGROUND

Cellular communications can be defined in various standards to enable communications between a user equipment and a cellular network. For example, a long-term evolution (LTE) network and Fifth generation (5G) network are wireless standards that aim to improve upon data transmission speed, reliability, availability, and more.

### BRIEF DESCRIPTION OF THE DRAWINGS

FIG. 1 is an illustration of user equipment (UE) power consumption, in accordance with one or more embodiments.

FIG. 2 is an illustration of power consumption in conjunction with wake up signal (WUS) monitoring, according to one or more embodiments.

FIG. 3 is an illustration of a base station connected with a UE, according to one or more embodiments.

FIG. 4 is an illustration of WUS monitoring by a UE in a sleep state, according to one or more embodiments.

FIG. 5 is an illustration of a variation for WUS monitoring for a radio resource control (RRC) connected UE, according to one or more embodiments.

FIG. 6 is an illustration of a variation for WUS monitoring for an RRC connected UE, according to one or more embodiments.

FIG. 7 is an illustration of WUS monitoring by a UE in an RRC connected state, according to one or more embodiments.

FIG. 8 is a process flow for WUS monitoring, according to one or more embodiments.

FIG. 9 is a process flow for WUS monitoring, according to one or more embodiments.

FIG. 10 is a process flow for WUS monitoring, according to one or more embodiments.

FIG. 11 is a process flow for WUS monitoring, according to one or more embodiments.

FIG. 12 is a process flow for WUS monitoring, according to one or more embodiments.

FIG. 13 illustrates an example of receive components, according to one or more embodiments.

FIG. 14 illustrates an example of a UE, according to one or more embodiments.

FIG. 15 illustrates an example of a base station, according to one or more embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

A wake up radio system can provide an efficient energy operation for a user equipment (UE), in which components of the main radio are activated from a sleep state in response to a trigger. The UE can conserve power by having components of the main radio remain in the sleep state, where they draw less power than in an awake state. The UE can further deliver a trigger to wake up the components when they are needed. The UE can include a wake up receiver (WUR), which is a low-power receiver for detecting a wake up signal (WUS) and, in response, sending an interrupt signal to wake up a main radio of the UE. The main radio can draw more power from the UE power source (e.g., battery) than the WUR, and therefore keeping the main radio in a sleep state conserves power. For regular operations, the main radio of the UE can communicate with the base station in the awake state and, from time to time, fall back into the sleep state to conserve power. The WUR can communicate with the base station to receive a wake-up signal to wake the main radio.

Regardless of whether the WUR is receiving information from the base station, or the main radio is receiving information from the base station, modern baseband communication is performed using a complex communication network. To effectuate communication between the UE and the base station, each have to agree on a common configuration to enable communication. The UE and the base station can agree on a common configuration using a control mechanism known as radio resource control (RRC). The UE can be in an RRC connected state, in which it is connected with the base station. In the RRC connected state, the base station can configure the UE with the common configuration. The common configuration can include a set of parameters that are necessary for the base station and the UE to communicate. During this RRC connected state, the cell that the UE is camped in can be known and the base station can use a cell-radio network temporary identifier (C-RNTI). The UE can monitor for the C-RNTI to determine whether a transmission from the base station is intended for the UE.

Furthermore, during this RRC connected state, the base station can configure the UE with a discontinuous reception (DRX) type including a connected DRX (CDRX) mode. In CDRX mode, the UE can periodically wake up and stay awake (e.g., on duration) to monitor for potential uplink (UL)/downlink (DL) data. The UE can then go back to sleep (e.g., off duration) after it finishes monitoring. Together, an on duration and an off duration can form a long DRX duration.

Embodiments of the present disclosure are described in connection with 5G networks. However, the embodiments are not limited as such and similarly apply to other types of communication networks, including other types of cellular networks, such as an LTE network.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities, which is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

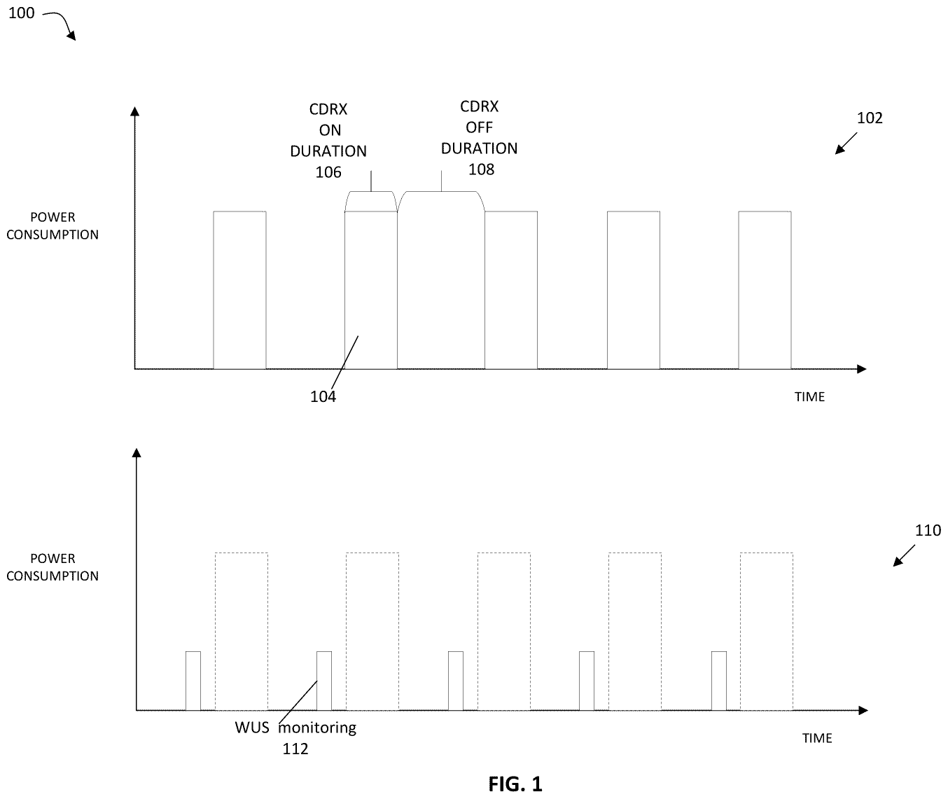

FIG. 1 is an illustration 100 of user equipment (UE) power consumption, in accordance with one or more embodiments. A first graph 102 is an illustration of power consumption during a CDRX on duration and includes time on an x-axis and power consumption on a y-axis. The first graph 102 further illustrates power consumption 104 by a UE during a CDRX on duration 106. As described above, during the CDRX on duration, the UE can be in an awake state and monitoring for potential DL transmissions. As further illustrated, the CDRX on duration is followed by a CDRX off duration, in which the UE does consume power to monitor for potential DL transmissions. It should be appreciated that although the UE can enter the CDRX mode to conserve power, in many instances, the UE expends power, during the CDRX on duration, monitoring the physical downlink control channel (PDCCH) without an actual grant. Therefore, the UE can experience increased power savings, by skipping unnecessary PDCCH monitoring during a DRX on duration and without increasing a delay.

The second graph 110 is an illustration of power consumption during wake up signal (WUS) monitoring and also includes time on an x-axis and power consumption on a y-axis. Power consumption during a CDRX on duration has been included as dashed lines for comparison. As illustrated, during WUS monitoring 112, the UE consumes less power than when the UE is monitoring during the CDRX on duration. To achieve maximum power savings gain, the power consumption for WUS monitoring should be lower than that for regular PDCCH monitoring and receiving transmissions on a physical downlink shared channel (PDSCH).

Embodiments described herein address the above referenced issues by introducing a WUS in RRC connected mode that can indicate to the UE whether to wake up or not for an upcoming CDRX on duration. If the UE receives a wake up indication (e.g., receives a WUS), the UE can wake up and monitor the PDCCH during an upcoming CDRX on duration. If the UE does not receive the wake up indication (e.g., does not receive a WUS), the UE can skip monitoring the PDCCH during the next CDRX on duration.

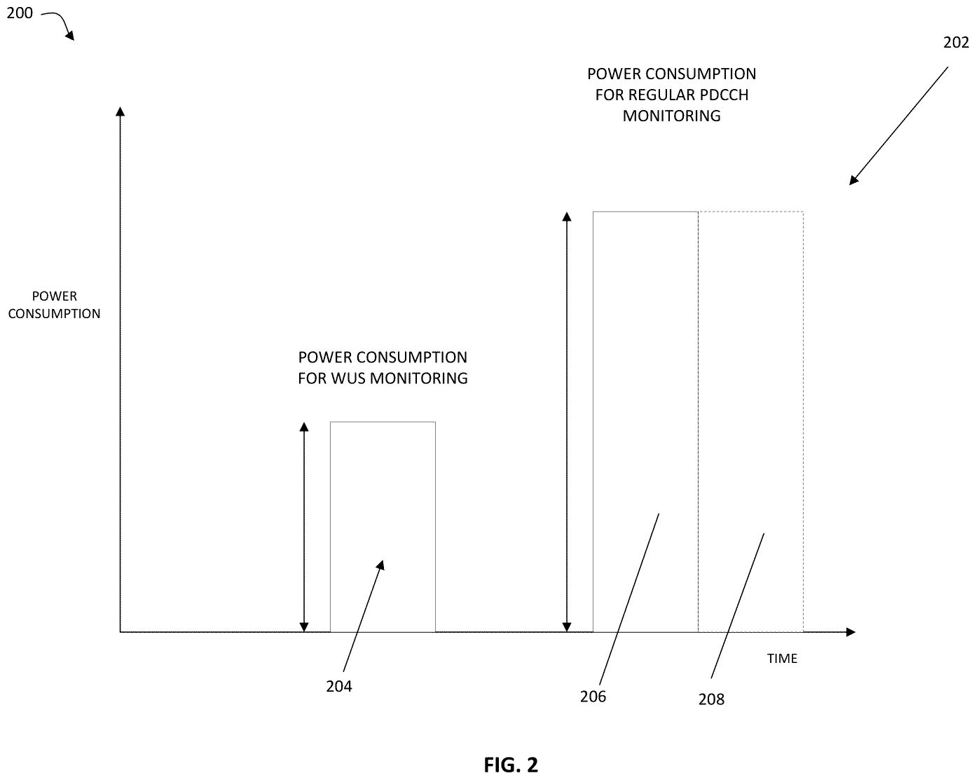

FIG. 2 is an illustration of power consumption in conjunction with WUS monitoring, according to one or more embodiments. The graph 202 is an illustration of power consumption during a CDRX on duration and includes time on an x-axis and power consumption on a y-axis. A power consumption block 204 is illustrated to describe UE power consumption while WUS monitoring during a sleep state. Block 206 is an illustration of an amount of power consumed by the UE monitoring the PDCCH during a CDRX on duration in the instance that a WUS is received. As illustrated, block 206 and block 208 can collectively form a long DRX duration, in which the UE monitors the PDCCH at an on duration (UE power consumption in the on duration is illustrated as block 206). The UE does not monitor the PDCCH in the off duration, in which power is conserved by not monitoring the PDCCH (UE power consumption is illustrated as block 208, where the dashed lines indicate no power consumption associated with PDCCH monitoring). Embodiments herein describe an instance where if a WUS is not received, even though the UE enters a CDRX on duration mode, the UE can conserve power by skipping PDCCH monitoring for subsequent DRX on durations until such time that a WUS is received.

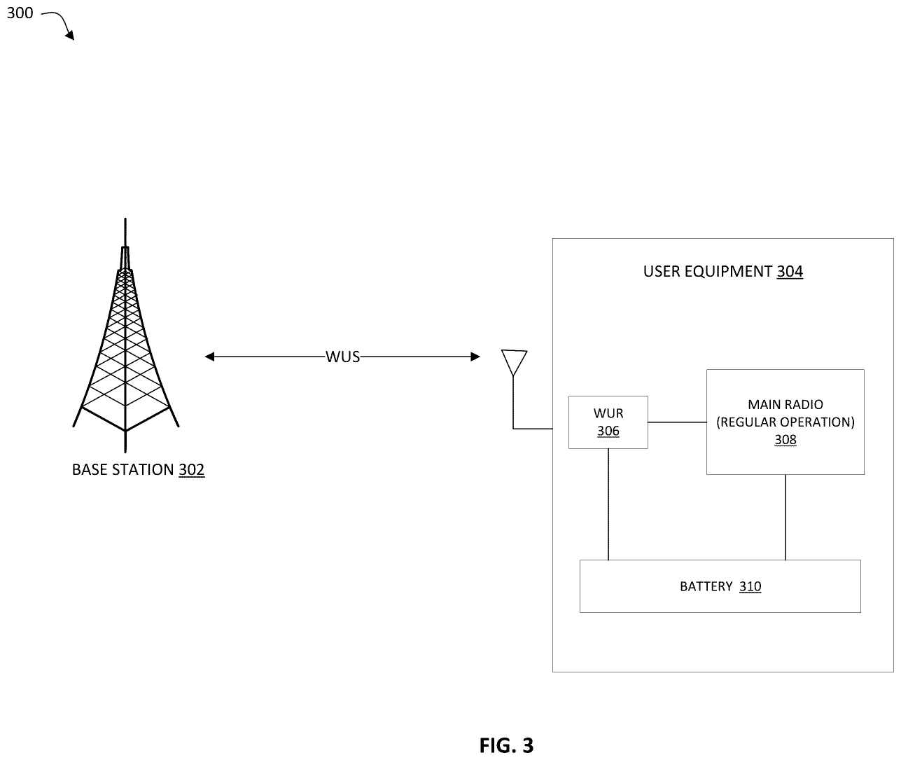

Embodiments herein describe a base station that can transmit a WUS to a UE, when the UE is in an RRC connected mode. FIG. 3 is an illustration of a base station connected with a UE, according to one or more embodiments. A base station 302 can transmit a WUS to a UE 304 The WUS can be a wake-up signal for the UE 304, which can be detected by the UE with a low-power receiver. The UE 304 can detect a WUS when there is no active data being transmitted. For example, the UE 304 can include a low-power radio (e.g., wake up receiver (WUR) 306) for detecting the WUS. The UE 304 can detect the WUS and enter into an awake state for the main radio. For example, the low-power radio 306 can detect the WUS and send an interrupt signal to awaken the UE's main radio 308. Although as illustrated, the trigger for the UE 304 to transition the main radio from a sleep state to an awake state is the WUS, it should be appreciated that other triggers as described below, can cause the UE 304 to transition from a sleep state to an awake state. There can also be triggers for causing the UE 304 to transition the main radio from an awake state to a sleep state. The UE 304 can conserve power (e.g., power from battery 310) by staying in a sleep state until such time that a trigger is received. There can, however, be a delay introduced by waiting for the trigger (e.g., WUS) and waking up the main radio 308. As illustrated, the WUR 306 and the main radio 308 are separate blocks, in some embodiments, the WUR 306 and the main radio 308 are included in the same block.

One having ordinary skill in the art will recognize the differences of the concepts described herein and concepts described in 3GPP release 16. For example, in 3GPP release 16, a WUS is always used on top of CDRX, and the WUS indicates whether the UE needs to wake up in the next DRX on duration. As described herein, the signal (e.g., WUS) can be independent from or work in conjunction with CDRX. Additionally, in 3GPP, the WUS is transmitted using the PDCCH, while embodiments described herein include a WUS that can be a signal designed for a low-power receiver (e.g., WUR 306). In 3GPP release 16, a DCI format 2_6 was introduced for notifying power saving information outside DRX active time for one or more UEs. DCI format 2_6 can be used for the WUS. The UE can be configured for WUS monitoring in the primary cell (PCell) and primary and secondary cell (PSCell). For a low power WUS concept described herein, if it is used in conjunction with CDRX, it can simply replace the WUS in 3GPP release 16 and the existing procedures can be reused. In the subsequent descriptions below, embodiments of a low power WUS without CDRX are described.

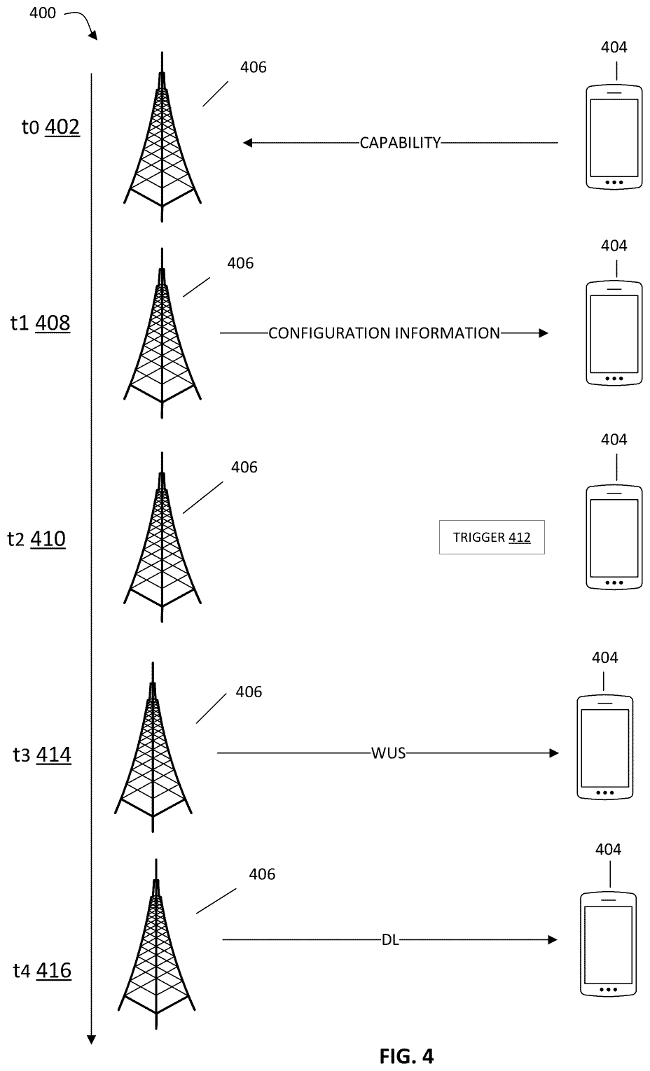

FIG. 4 is an illustration 400 of WUS monitoring by a UE, according to one or more embodiments. At to 402, a UE 404 can transmit an indication to a base station 406 of a capability to perform WUS monitoring in an RRC connected mode.

The UE 404 can additionally report one or more switching gap values for a transition from WUS monitoring (e.g., sleep state) to a regular operation (e.g., awake state). A regular operation can include monitoring the PDCCH for an incoming transmission. A switching gap should at least cover the processing time required for the UE 404 to receive the WUS from the base station 406 and wake up the UE's main radio to perform a regular operation. In general, the switching gap can depend upon a sleep state type that the main radio enters during WUS monitoring. The switching gap value can be small if the main radio enters a micro/shallow sleep. The switching gap value can be large if the main radio enters a deeper sleep state. The switching gap value can be defined with respect to the start or end of the WUS. For example, the switching gap value can be defined with respect to a starting symbol of the WUS or a last symbol of the WUS. If, the UE 404 can report multiple switching gap values, the base station 406 can configure one or more of the values based on, for example, a latency requirement of the data to be transmitted using the PDCCH, network load, or another appropriate factor.

The UE 404 can additionally report one or more switching gap values from a trigger to start WUS monitoring and the actual start of WUS monitoring. These switching gap values allow the base station to determine how long after the UE receives a trigger, that the UE is ready for WUS monitoring. Therefore, the base station can determine how long after the trigger the base station 406 needs to wait before transmitting the WUS. In some instances, the base station 406 can use downlink control information (DCI) to trigger the UE 404 to perform WUS monitoring. In these instances, the one or more of these switching gap values can be defined with respect to the start of a DCI transmission or the end of the DCI transmission. For example, the switching gap value can be defined with respect to a starting symbol of the DCI or a last symbol of the DCI. If single switching gap value is be reported, the UE 404 can report the switching gap value independently from other UE capabilities. If multiple switching gap values are reported, the UE can report the switching gap values with correspondence to other capabilities. For example, a switching gap value for from WUS monitoring (e.g., sleep state) to a regular operation (e.g., awake state) and a switching gap value from a trigger to start WUS monitoring and the start of WUS monitoring can be reported as a pair. In other instances, a switching gap value from a trigger to start WUS monitoring and the start of WUS monitoring can be related to a WUR architecture or performance.

A switching gap value for switching from WUS monitoring (e.g., sleep state) to a regular operation (e.g., awake state) and a switching gap value from a trigger for WUS monitoring and the start of WUS monitoring can be defined based on subcarrier spacing (SCS). For example, the switching gap values can be in terms of symbols or slots, with reference to a corresponding SCS or a reference SCS.

The UE 404 can additionally report one or more multiple levels of WUR performance to the base station 406. For example, the UE 404 can report WUR sensitivity or a required signal to interference noise ratio (SINR) to achieve one or more performance targets (e.g., in terms of false alarm probability and missed detection probability). In some instances, there can be a multiple pre-defined values or value ranges for the reported WUR, and the UE 404 can report one of the values or multiple values. The UE 404 can report difference values based on a WUR architecture and power consumption level. For example, a higher sensitivity value can be reported for a WUR architecture that exhibits a lower power consumption. The UE 404 can support multiple WUR architectures that are associated with respective performance metrics. The base station 406 can transmit an indication to the UE 404 to use a the WUR architecture associated with a particular performance level based on a deployment scenario and the UE's characteristics, such as radio frequency (RF) condition and mobility.

The above-mentioned performance targets can be pre-defined or configured by the base station 406. For example, the base station 406 can configure the UE 404 with the performance targets by broadcasting a system information block (SIB) message. For example, the base station 406 can configure a performance target of a 1% false alarm probability and a 1% missed detection probability. The base station 406 can define multiple performance targets, and the UE 404 can report an achievability for each of the performance targets. In some instances, different time domain and frequency domain resources can be used for WUS monitoring, and the UE can report the achievability of the performance targets based on the different time domain and frequency domain resources.

At t₁ 408, the base station 406 can transmit configuration information to the UE 404. In some instances, the base station 406 can transmit the configuration information for WUS monitoring to the UE 404 in RRC connected mode. The configuration information can include a carrier to be monitored with the WUS. For each identified carrier, the configuration information can further include a time domain resource. In some instances, the UE 404 can be configured to continuously monitor for the WUS, meaning that the network may transmit WUS starting at any time. In other words, the WUR of the UE 404 can monitor each symbol in each slot during a CDRX on duration. In this instance, the base station 406 does not need to configure the UE 404 with a time domain resource for WUS monitoring. In other instances, the base station 406 can configure the UE 404 to periodically monitor for the WUS. The base station 406 can configure the UE 404 with periodicity and offset, which determines when the UE should monitor WUS. For example, the base station 406 can configure the UE 404 to monitor for the WUS in each slot, and the WUS may start at the slot boundary. In another example, the base station 406 can configure the UE 404 monitor for the WUS every X (e.g., 4) slots, if the data to be received by a subsequent PDCCH transmission is not delay sensitive.

Alternatively, or additionally, in some instances, the base station 406 can trigger the UE 404 to perform WUS monitoring using a DCI. In these instances, the UE 404 can monitor for the WUS based on a time offset from the last symbol of DCI, which may be subject to UE's capability and the SCS of a component carrier (CC).

In some instances, the base station 406 can configure the UE 404 with a particular WUS duration, if the UE can support multiple WUS durations. In these instances, the WUS duration can be based on a UE RF condition and/or performance requirements on WUS detection.

The base station 406 can also configure the UE 404 with a frequency domain resource for WUS monitoring. The UE 404 can use the frequency domain resource to monitor for the WUS. In some instances, the base station 406 can define a fixed bandwidth for the WUS. In these instances, base station 406 can indicate to the UE 404 that the frequency domain resource may be indicated as the starting position, or the center position, or the ending position of the bandwidth in the frequency domain. In some instances, the base station 406 can provide one reference point to determine the starting position, center position, or ending position by higher layers (e.g., by using Absolute Radio Frequency Channel Number (ARFCN). In some instances, WUS monitoring can be supported over multiple bandwidths. In these instances, the base station 406 can configure the UE 404 with each of the multiple bandwidths. Furthermore, the base station 406 can indicate the position and the bandwidth with a certain granularity, which can include one or more physical resource blocks (PRBs) of the carrier, or one or more resource blocks defined specifically for the WUS. The granularity associated with the position may or may not be the same as the granularity associated with the bandwidth.

Additionally, the base station 406 can configure the UE 404 with a switching gap value for the transition from WUS monitoring to regular operation. The switching gap value can be equal to or larger than the minimum time gap required between the WUS and the first reception by the UE 404 (e.g., the first PDCCH monitoring occasion) or transmission after UE 404 wakes up. The base station 406 can configure the switching gap based on the UE's capability. The base station 406 can define the switching gap value with reference to the start or the end of the WUS. In other words, the minimum time gap that is required between the start of WUS or the end of the WUS and the first reception by the UE 404 (e.g., the first PDCCH monitoring occasion) or transmission after UE 404 wakes up. In some instances, multiple switching gap values can be supported in the standards, or the UE 404 has reported multiple switching gap values. In these instances, the base station 406 can configure the UE 404 with a switching gap value based on, for example, the latency requirement of the data to be received via the PDCCH, a network load, another appropriate parameter. Alternatively, the base station 406 can configure the UE 404 with multiple switching gap values. In some instances, the base station 406 can dynamically indicate a switching gap value when the base station indicates to the UE 404 to monitor for the WUS. In other instances, the base station 406 can configure the UE 404 with a default switching gap value.

In some instances, the base station 406 does not configure the UE 404 with a switching gap value for the transition from WUS monitoring to regular operation if a single switching gap is pre-defined in the technical standards.

Additionally, the base station 406 can configure the UE 404 with a switching gap value for the time from the trigger for WUS monitoring to the start of WUS monitoring. This switching gap value can be equal to or larger than the minimum switching gap from the trigger for WUS monitoring to the start of WUS monitoring. In some instances, this switching gap value can be based on the UE's capability. In some instances, either the standards support multiple switching gap values, or the UE 404 can report multiple switching gap values. In these instances, the base station 406 can configure the UE 404 with a particular switching gap value, for example, based on a chosen WUS operation. In some instances, switching gap value for the time from the trigger for WUS monitoring to the start of WUS monitoring is provided in the technical standards. In these instances, the base station 406 does not configure the UE 404 with this switching gap value.

Additionally, the base station 406 can configure the UE 404 with an identifier (UE ID) or a group identifier for a group of UEs. The UE 404 can use the UE ID or group identifier to determine whether a detected WUS is intended for the UE 404. For example, the UE 404 can determine whether the WUS is associated with a UE ID that is associated with the UE 404. If the WUS is associated with the UE ID, the UE can begin transitioning to an awake state. If the WUS is not associated with the UE ID, the UE 404 can remain in a sleep state. The base station 406 can implicitly embed the UE ID in the WUS (e.g., impacting what sequence or resource is used by WUS) or the UE ID can be directly carried in the WUS as part of the payload.

The base station 406 can configure or re-configure the UE 404 via higher layer signaling (e.g., RRC, medium access control-control element (MAC-CE)) with the time domain and frequency domain resources based on, for example, the UE RF condition and the expected performance of the UE. The base station 406 can make the decision based on the reported WUR performance from the UE, if available.

In some instances, the base station 406 can configure multiple sets of time domain and frequency domain resources for the UE 404 to perform WUS monitoring. In some other instances, the UE 404 can derive multiple sets of time domain and frequency domain resources based on the network's configuration. In these instances, the base station 406 can choose one or more of the configured resources to transmit the WUS to the UE 404. In some instances, the multiple sets of time domain and frequency domain resources can have a different number of resources. The base station 406 can select the resources based on UE's RF condition or expected reliability. This concept is similar to different aggregation levels for PDCCH. Which of the configured resources is to be used for WUS monitoring can be carried or embedded within the WUS (e.g., at the beginning of the WUS). Alternatively, in some instances the UE 404 may need to perform a blind detection to determine which time domain and frequency domain resource are used for WUS monitoring. However, blind detection can increase the complexity and power consumption for the WUR, and therefore a careful design can be used.

The base station 406 can provide a WUS configuration associated with one carrier, a plurality of carriers, or all the configured carriers. This means that the main radio of these one or more carriers are controlled by the WUS. The associated carrier(s) may be indicated as part of the WUS configuration, or the associated carrier(s) can be pre-defined. The associated carrier(s) may include the CC on which the WUS is to be monitored, a CC group that includes the CC on which the WUS is to be monitored, or all the CCs configured for the UE 404. In some embodiments, the WUS configuration may include an explicit indication of the CCs that are associated with the WUS (e.g., via a bitmap or a list of CC indices).

The base station 406 can provide finer granularity by associating the WUS configuration information with one or more search space set(s) on one or multiple carriers. In these instances, when the UE 404 monitors for the WUS (e.g., sleep state), the UE 404 may not need to monitor the PDCCH associated with these search space set(s). When the UE 4033 moves out of a WUS monitoring state (e.g., awakens), it can monitor the PDCCH associated with these search space set(s).

The base station 406 can configure the WUS to be UE-specific, but multiple UEs can be configured with the same resource. If the base station 406 configures multiple UEs with the same group ID, a single WUS can wake up each of these multiple UEs simultaneously. This can provide a tradeoff between UE power saving and resource overhead.

At t₂, 410, the UE can receive a trigger 412 for transitioning the main radio from an awake state to a sleep state for WUS monitoring. The trigger 412 can be in various forms. For example, the trigger can be an explicit indication in the DCI. One DCI bit can be used to indicate to the UE 404 that it can switch to WUS monitoring. If the base station 406 has configured the UE 404 with multiple switching gap values from the trigger 412 for WUS monitoring to the start of WUS monitoring, the DCI can further include an indication of which switching gap value to use. The UE 404 can in turn use the switching gap value to determine when the WUS monitoring should start. The base station 406 can have defined this switching gap value with reference to the start of the DCI or the end of the DCI. Prior to the start of WUS monitoring, the UE 404 may or may not continue the regular operation. Alternatively, or additionally, the base station 406 can use the DCI to indicate the start of WUS monitoring together with skipping PDCCH monitoring, either explicitly or implicitly. The UE 404 can switch to WUS monitoring after the end of indicated PDCCH skipping. For example, the base station 406 can provide an indication to skip PDCCH monitoring for a number of slots, in which case the UE 404 does not need to monitor for the WUS. The UE 404 can start WUS monitoring after the indicated number of slots. If the base station 406 has configured the UE 404 with multiple switching gap values for the transition from WUS monitoring (sleep state to awake state), the base station can further use the DCI to indicate which of these switching gap values to be applied when the UE 404 does receive the WUS in the future. Using this indication, the UE 404 can determine which sleep state the main radio can go into in response to the trigger 412. The indications can use new field(s) in DCI or re-purpose existing field(s).

The trigger 412 can also be a time-based trigger. The UE 404 can switch to WUS monitoring (e.g., sleep state) after not having received any DCIs for a time duration. The base station 406 can either configure the time duration or the time duration can be pre-determined in the standards.

The trigger 412 can also be based on a condition. For example, the UE 404 can transition back to WUS monitoring (sleep state) immediately after a transmission/reception in the awake state is completed. Certain conditions can be based on a trigger for causing the UE 404 to transition from a WUS monitoring state (e.g., sleep state) to a regular operation (e.g., awake state). For example, the UE 404 can transition from WUS monitoring to regular operation if it needs to transmit or receive to perform semi-statically configured DL reception and/or UL transmission, even when no WUS is received. In another example, the UE 404 may switch to regular operation after monitoring WUS for a pre-defined or configured time. Back to the trigger 412 that is condition based, if the UE 404 transitions to regular operation (e.g., awake state) from the WUS monitoring state (e.g., sleep state) to measure synchronization signal block (SSB) and/or channel stat information-reference signal (CSI-RS) or semi-persistent scheduling physical downlink shared channel (SPS PDSCH), the UE 404 can go back to a WUS monitoring state immediately after the reception if no further action is needed.

The trigger 412 can be a UE 404 triggered state switching. In the instance that the UE 404 has no uplink (UL) and downlink (DL) data for a period, the UE 404 can send the UL signal to inform the base station 406, that the UE 404 will switch to WUS monitoring state. For example, the UE 404 can partially reuse a scheduling request (SR) resource (e.g., same SR periodicity, physical uplink control channel (PUCCH) format 0 with different sequence cyclic shift from SR). This may avoid any misalignment between the base station 406 and the UE 404 on the UE state.

As indicated above, the UE 404 can (although not illustrated for all cases) have a trigger for a transition from a WUS monitoring state (sleep state) to a regular operation state (awake state). This trigger can be that once the UE 404 receives the WUS (as illustrated by 414), the UE 404 switches to regular operation according to configuration. In this instance, the corresponding switching gap value (either pre-defined, or configured, or dynamically indicated previously) can be applied by the UE 404.

Another trigger for a transition from a WUS monitoring state (sleep state) to a regular operation state (awake state) can be that the UE can switch to the regular operation state when it has data to transmit (e.g., to transmit SR or configured grant (CG) PUSCH).

Another trigger for a transition from a WUS monitoring state (sleep state) to a regular operation state (awake state) can be that the UE 404 can switch from a WUS monitoring state to a regular operation state if it needs to transmit or receive to perform semi-statically configured DL reception and UL transmission, even when no WUS is received. The semi-statically configured DL reception in this instance should at least exclude the PDCCH monitoring in some or all UE-specific search space sets, because the power saving gain comes from replacing PDCCH monitoring with WUS monitoring. In one alternative, based on UE-specific search space configuration and/or additional configuration, the UE 404 can selectively exclude some, but not all PDCCH monitoring occasions. For example, the UE 404 can selectively exclude some, but not all PDCCH monitoring occasions based on different associated priority. The types of semi-statically configured DL reception and UL transmission that would trigger the UE to get out of the WUS monitoring state can be pre-defined or configurable by the network. For example, it can be defined or configured that only SPS PDSCH or CG PUSCH (not any other types of semi-statically configured DL reception and UL transmission) triggers the switch for the UE 404 from a WUS monitoring state (sleep state) to a regular operation state (awake state).

Another trigger for a transition from a WUS monitoring state (sleep state) to a regular operation state (awake state) can be that the UE 404 can switch to a regular operation state after being in a monitoring WUS state for a pre-defined or configured time. For example, the UE 404 may need to measure SSB and/or CSI-RS from time to time for beam tracking and/or for a radio link monitoring (RLM) purpose.

It should be appreciated that the switching gap value may not be applicable for certain triggers for a transition from a WUS monitoring state (sleep state) to a regular operation state (awake state). For example, if the trigger is any of having data to transmit, needing to transmit or receive to perform semi-statically configured DL reception and UL transmission, even when no WUS is received, or after monitoring WUS for a pre-defined or configured time, the UE 404 can prepare in advance for the transition, given the known transmission/reception time based on configuration.

In addition to the capabilities that the UE can report (e.g., at to 402), that UE 404 can additionally indicate its support for one or multiple of the above options for the transitioning. Furthermore, some or all of the triggering options above can be combined and used together as configured by the base station 406 and subject to UE 404 capability.

At t₃ 414, the base station 406 can transmit the WUS to the UE 404. In some instances, the WUS can be a signal that is not transmitted using the PDCCH. The WUS can be received by a low-power receiver (e.g., WUR) of the UE 404. The low-power receiver can transmit an interrupt signal to the main radio of the UE 404. In response the main radio can wake up and monitor for a DL transmission using the PDCCH.

At t₄ 416, the base station 406 can transmit a DL transmission to the UE 404 using the PDCCH. The DL transmission can be received by the main radio of the UE 402.

The embodiments described herein can include different variations for WUS operation for RRC connected UEs. The above described descriptions assume that the UE is either in a WUS monitoring state or a regular operation state.

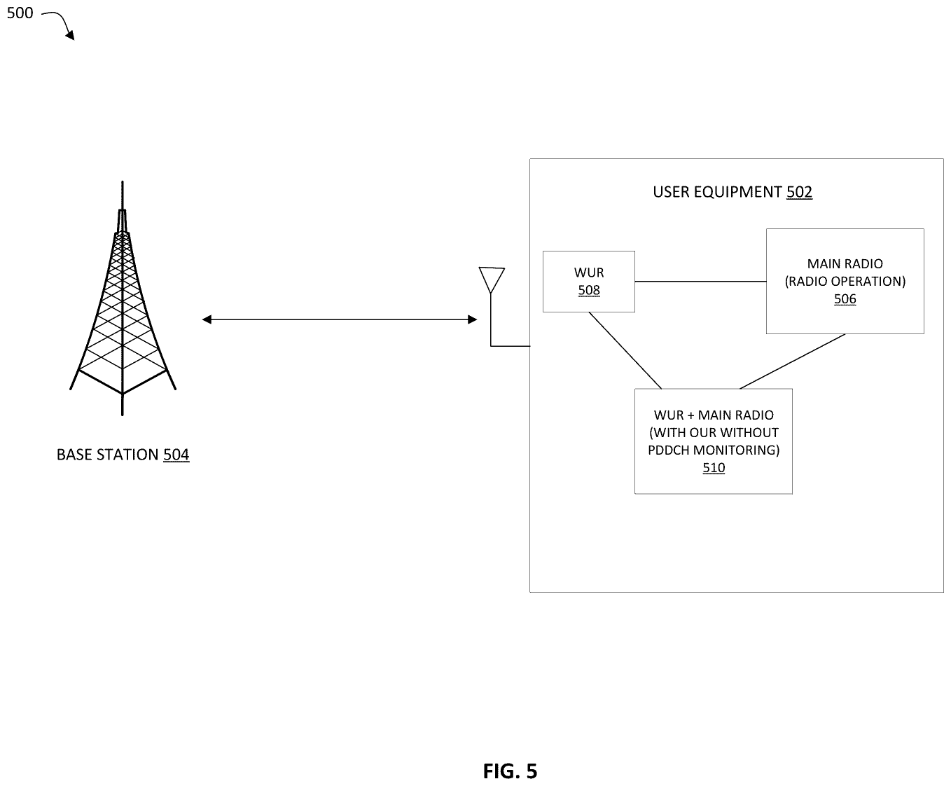

FIG. 5 is an illustration 500 of a variation for WUS monitoring for an RRC connected UE, according to one or more embodiments. As illustrated, a UE 502 is in an RRC connected state with a base station 504. Under certain triggering conditions (e.g., the UE 502 needs to transmit or receive to perform semi-statically configured DL reception and UL transmission, even when no WUS is received, or the UE 502 switches to regular operation after monitoring WUS for a pre-defined or configured time), the UE 502 can perform transmissions/receptions on the main radio 506 without PDCCH monitoring, while monitoring WUS on the WUR 508 at the same time. It should be appreciated that the WUR+main radio 510 is illustrated as a logical entity for performing the above described functionality and does not imply a distinct hardware component of the UE 502. If the UE 502 performs a particular action using the main radio and then goes back to WUS monitoring directly (e.g., the UE 502 switches back to WUS monitoring immediately after the transmission/reception is completed), there may not be a need for the UE 502 to monitor the PDCCH and/or stop WUS monitoring.

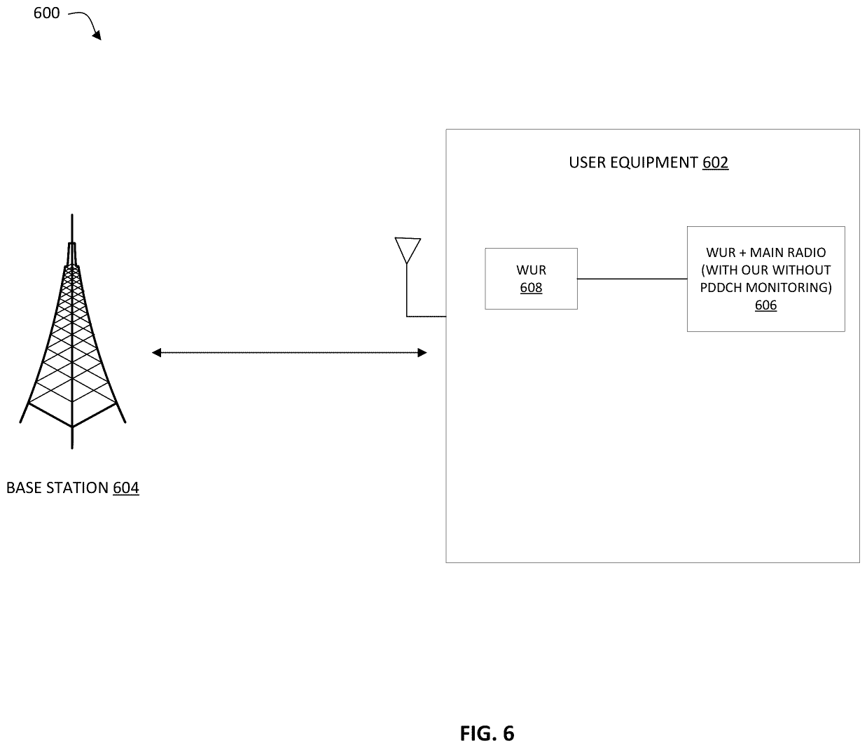

FIG. 6 is an illustration 600 of a variation for WUS monitoring for an RRC connected UE, according to one or more embodiments. As illustrated, a UE 602 is in an RRC connected state with a base station 604. In this variation, the UE 602 can always monitor WUS regardless of what is being transmitted/received on the main radio 606. For example, the UE 602 can perform regular operation on the main radio 606, including PDCCH monitoring, and monitor WUS at the same time. It may be argued that WUS monitoring is not necessary if the UE monitors PDCCH. However, in this variation, the power consumption of WUR 608 can be very low compared to that of the main radio 606, so the additional cost of monitoring WUS is minimum. This avoids the application delay that is needed when the UE switches from the regular operation to WUS monitoring.

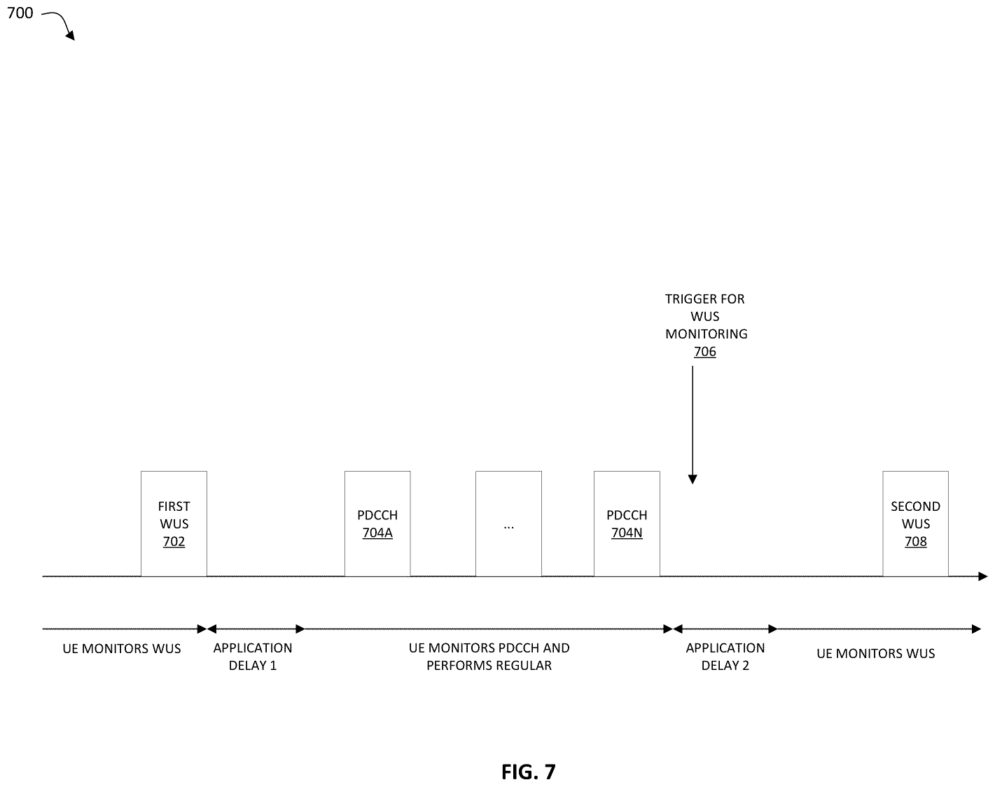

FIG. 7 is an illustration 700 of WUS monitoring by a UE in an RRC connected state, according to one or more embodiments. It should be appreciated that the height of the blocks in FIG. 7 are not intended to convey an amount of power consumption by the UE. A UE can be triggered to enter a WUS monitoring state (e.g., sleep state) and perform WUS monitoring. The WUS monitoring can be performed by a WUR of the UE. The UE can receive a first WUS 702 from a base station while in the WUS monitoring state. The first WUS 702 can be a signal that may or may not be transmitted using the PDCCH.

Based on receiving the first WUS 702, the UE can transition to an awake state. During the transition the WUR can transmit an interrupt signal to the main radio to wake up the main radio. The application delay between receiving a trigger to enter the awake state (which as illustrated in FIG. 7 is the first WUS 702) can be associated with a switching gap value received by the UE from the base station via configuration information. It should be appreciated that in some instances, the UE can transition from the sleep state to the awake state without receiving the WUS. In these instances, the UE can conserve power by not monitoring the PDCCH.

During the awake state, the UE can receive one or more transmissions via the PDCCH 704A-704N. For example, the main radio of the UE can periodically monitor the PDCCH over multiple long CDRX cycles to receive the one or more transmissions.

The UE can receive a trigger for WUS monitoring 706 and begin to transition from the awake state to a sleep state. For example, the UE's main radio can enter sleep state and the WUR can initialize to monitor for a WUS. In some embodiments, the trigger for WUS monitoring can be received via DCI from the base station. The application delay between the awake state and the sleep state can be associated with a switching gap value received from the base station via configuration information.

Once the UE enters the sleep state, the UE monitors for the WUS. For example, the WUR of the UE monitors for the WUS while the main radio is in a sleep state. The UE can receive a second WUS 708 from the base station. The second WUS 708 can cause the UE to transition from the sleep state back to the awake state. For example, in response to receiving the second WUS 708, the WUR can send another interrupt signal to wake up the main radio. Once the main radio wakes up, it can begin monitoring the PDCCH for a downlink transmission.

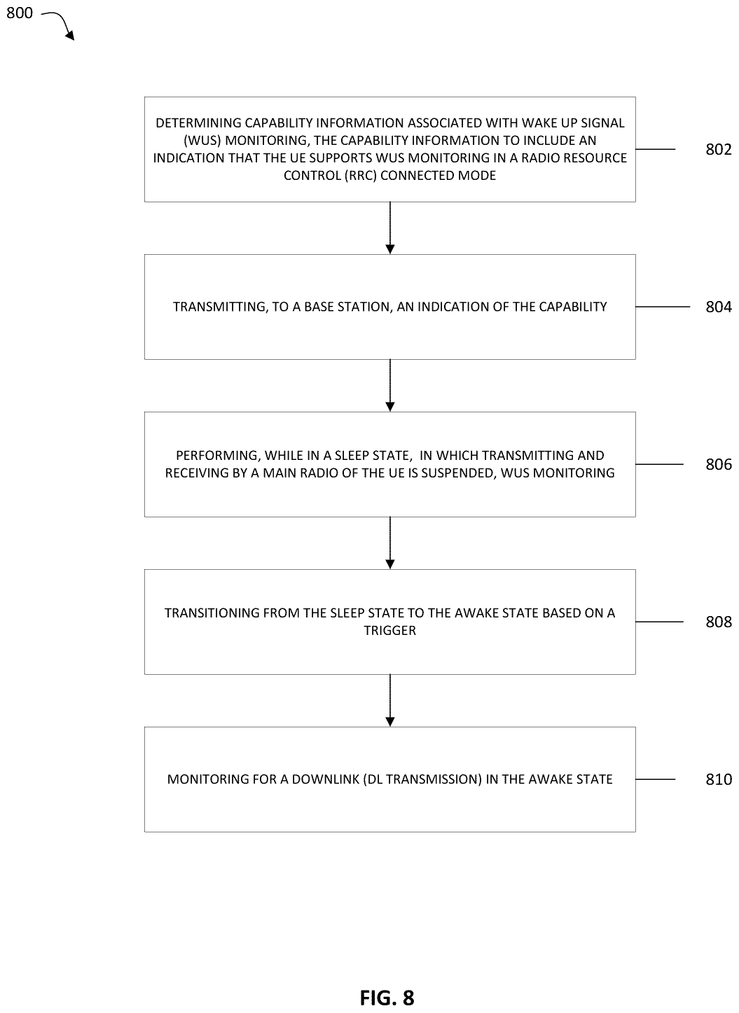

FIG. 8 is a process flow 800 for WUS monitoring, according to one or more embodiments. At 802, the method can include the UE determining capability information associated with wake-up signal (WUS) monitoring, the capability information to include an indication that the UE supports WUS monitoring in a radio resource control (RRC) connected mode.

At 804, the method can include the UE transmitting an indication of the capability to a base station. The base station can be associated with a PCell or a PSCell on which the UE is camped. The capability can include one or more capabilities associated with the UE.

At 806, the method can include the UE performing, while in a sleep state, WUS transmitting and receiving by a main radio of the UE is suspended. The monitoring can be performed by a WUR of the UE and the PDCCH can be to be performed by a main radio in an awake state but suspended while the main radio is in a sleep state.

At 808, the method can include the UE transitioning from the sleep state to the awake state based on the trigger. The trigger can be lower power signal, such as the WUS. The base station can transmit the WUS to the UE without using the PDCCH, and the WUS can be received by the WUR. The transition can include the WUR transmitting an interrupt signal to the main radio to wake up. The transition can be associated with a switching gap value that includes a time from switching to from the sleep state to the awake state. The time can help the base station determine when it can send a transmission to the UE.

At 810, the method can include the UE transmitting and receiving by a main radio of the UE in the awake state. In particular, the monitoring can be performed by the main radio, while the WUR remains in an idle state.

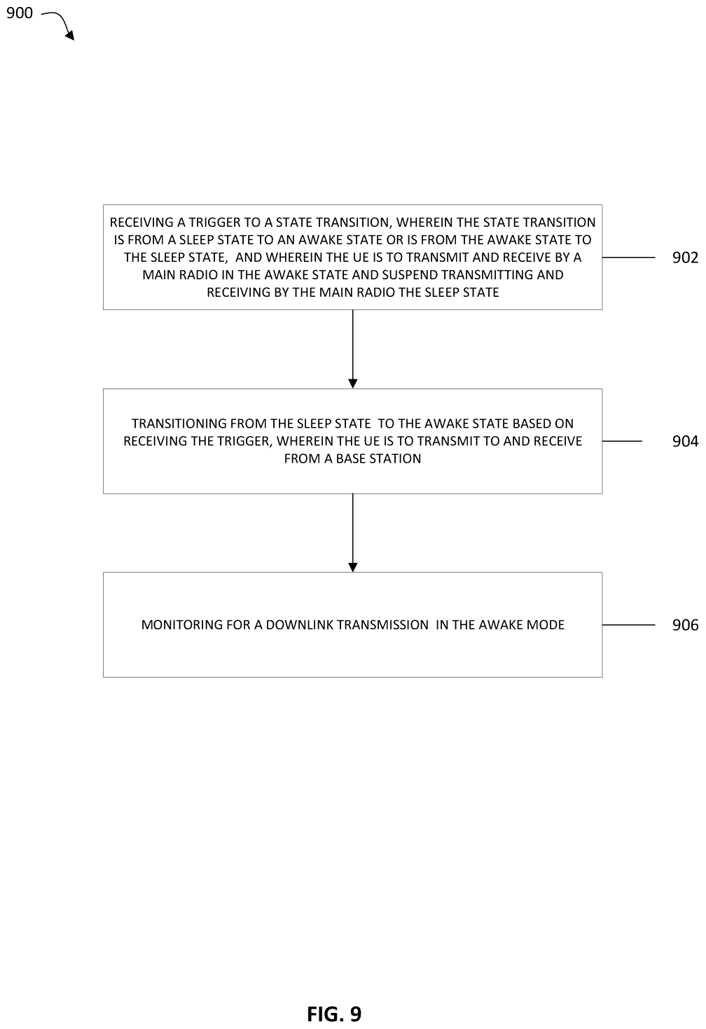

FIG. 9 is a process flow 900 for WUS monitoring, according to one or more embodiments. At 902, the method can include a UE receiving a trigger to a state transition, wherein the state transition is from a sleep state to an awake state, and wherein the UE is transmitting and receiving by a main radio of the UE in the awake state and suspend transmitting and receiving by the main radio in the sleep state.

At 904, the method can include the UE transitioning from the sleep state to the awake state based on receiving the trigger, wherein the main radio of the UE is to is to transmit and receive while in the awake state. For example, the UE can include a main radio that is in a sleep state. In response to receiving the trigger, the UE can wake up the main radio for transmitting and receiving.

At 906, the method can include the UE monitoring for transmissions and receptions by a main radio of the UE, based on being in the awake state. As indicated above, the monitoring can be performed by the main radio of the UE.

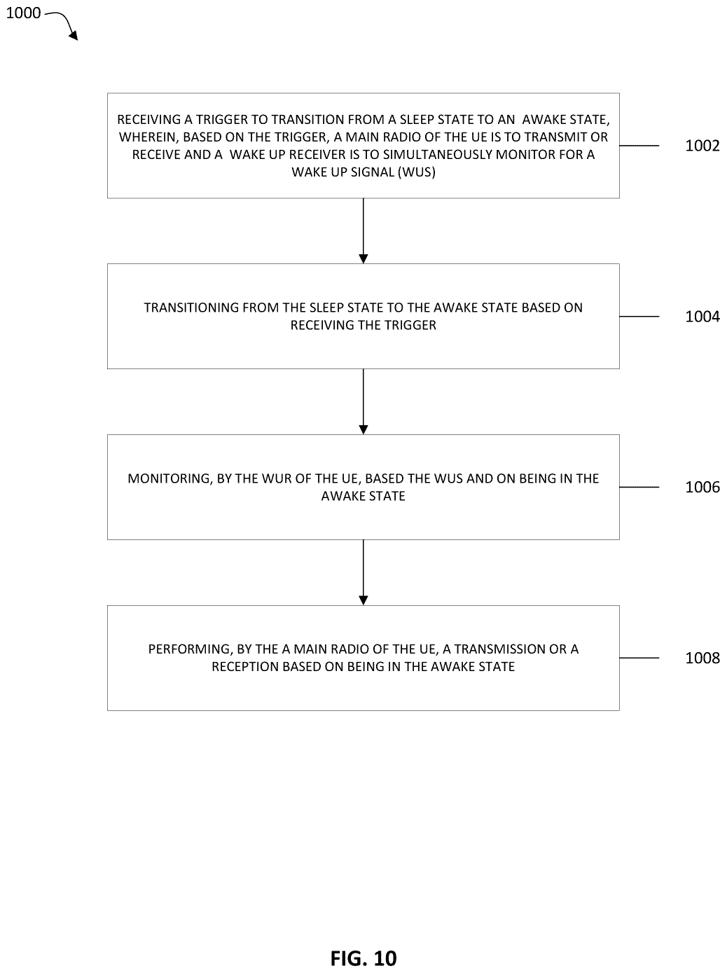

FIG. 10 is a process flow 1000 for WUS monitoring, according to one or more embodiments. At 1002, the method can include a UE receiving a trigger to transition from a sleep state to an awake state, wherein, based on the trigger, a main radio of the UE is to transmit or receive and a WUR of the UE is to simultaneously monitor for a WUS. In this embodiment, rather than alternating states to monitor for the WUS and transmitting and receiving by a main radio of the UE, the UE can simultaneously monitor for the WUS and perform transmitting and receiving operations that are not necessarily associated with the PDCCH.

At 1004, the method can include the UE transitioning from the sleep state to the awake state based on receiving the trigger. The main radio of the UE can be in a sleep state and, based on the trigger, transition to an awake state.

At 1006, the method can include the WUR of the UE monitoring for the WUS based on being in the awake state.

At 1008, the method can include the main radio of the UE performing transmitting or receiving based on being in the awake state. This can be simultaneous to the WUR monitoring for the WUS. The transmitting and receiving can further not necessarily be associated with the PDCCH.

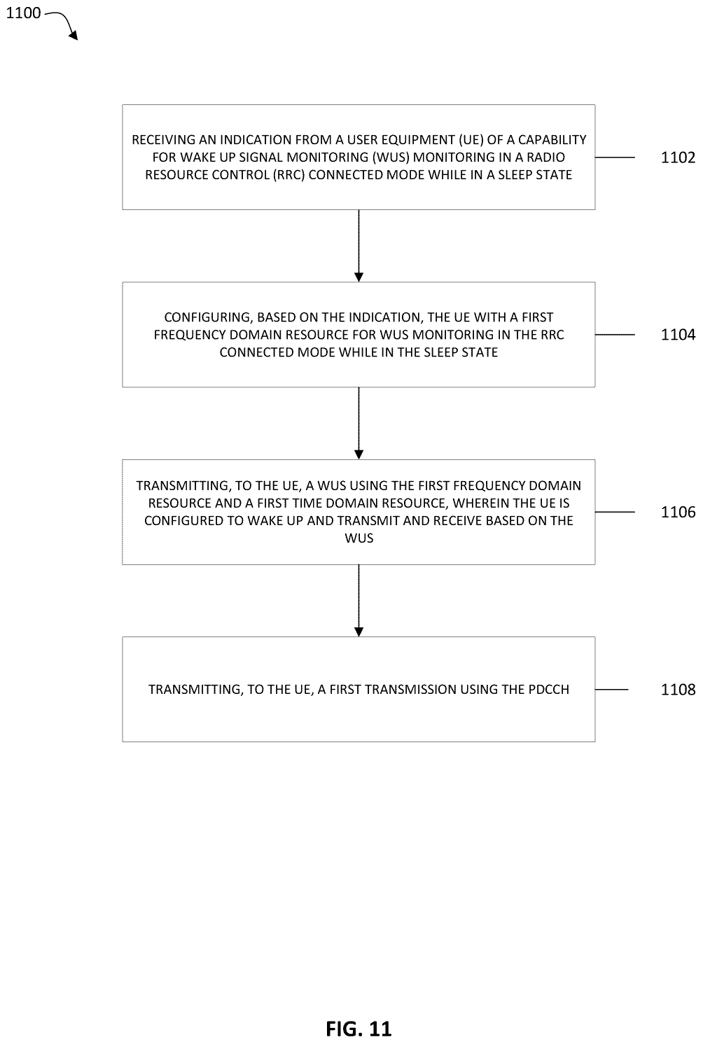

FIG. 11 is a process flow 1100 for WUS monitoring, according to one or more embodiments. At 1102, the method can include a base station receiving an indication from a user equipment (UE) of a capability for wake up signal (WUS) monitoring in a radio resource control (RRC) connected mode while in a sleep state.

At 1104, the method can include the base station configuring, based on the indication, the UE with a first frequency domain resource for WUS monitoring in the RRC connected mode while in the sleep state. In this step, the base station can configure the UE with a time domain resource, however the time domain resource may not be configured for WUS monitoring.

At 1106, the method can include the base station transmitting, to the UE, a WUS using the first frequency domain resource and a first time domain resource, wherein the UE is configured to wake up and monitor a physical downlink control channel (PDCCH) based on the WUS. The WUS can be detected by a low power receiver. The base station can transmit the WUS without using the PDCCH. In some instances, the WUS can include a UE identity to notify the UE as to whether it is the intended recipient.

At 1108, the method can include the base station transmitting, to the UE, a first transmission using the PDCCH. The UE can be in an awake state, and in particular the main radio of the UE can be in an awake state. The main radio of the UE can receive the transmission using the PDCCH.

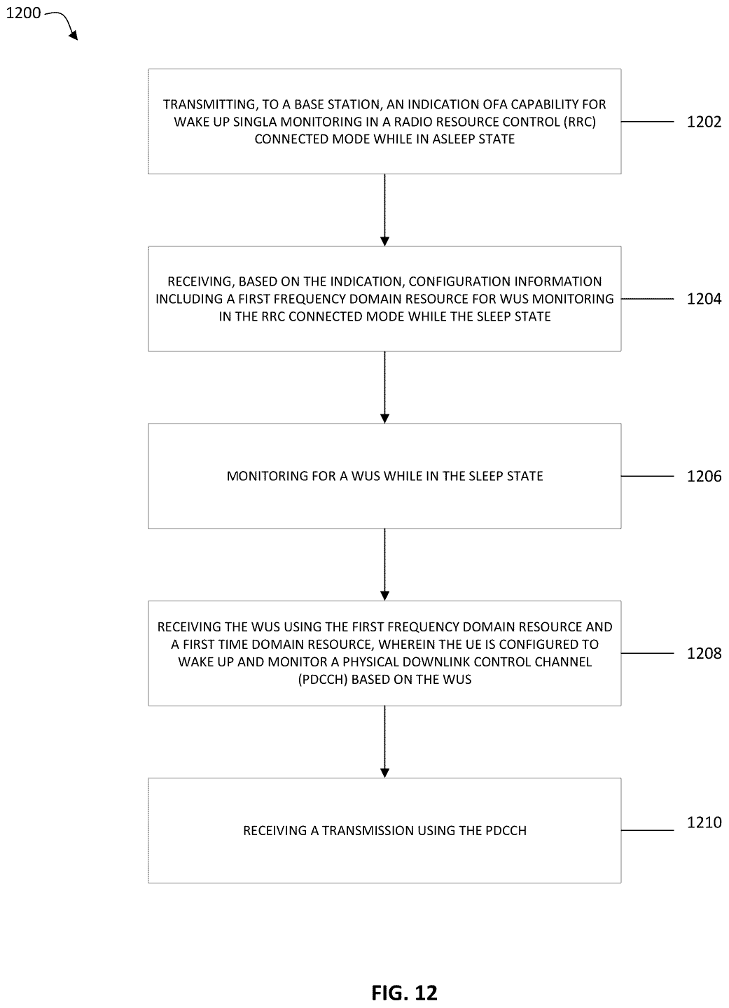

FIG. 12 is a process flow 1200 for WUS monitoring, according to one or more embodiments. At 1202, the method can include a UE transmitting, to a base station, an indication of a capability for WUS monitoring in a radio resource control (RRC) connected mode while in a sleep state.

At 1204, the method can include the UE receiving, based on the indication, configuration information including a first frequency domain resource for WUS monitoring in the RRC connected mode while in the sleep state. In this step, the base station can configure the UE with a time domain resource, however the time domain resource may not be configured for WUS monitoring.

At 1206, the method can include the UE monitoring for a WUS while in the sleep state. In particular a WUR of the UE can monitor for the WUS while the main radio is in the sleep state.

At 1208, the method can include the UE receiving the WUS using the first frequency domain resource and a first time domain resource, wherein the UE is configured to wake up and monitor a physical downlink control channel (PDCCH) based on the WUS. As indicated above, the main radio can wake up to perform PDCCH monitoring. For example, the WUR can send an interrupt signal to wake up the main radio.

At 1210, the method can include the UE receiving a transmission using the PDCCH.

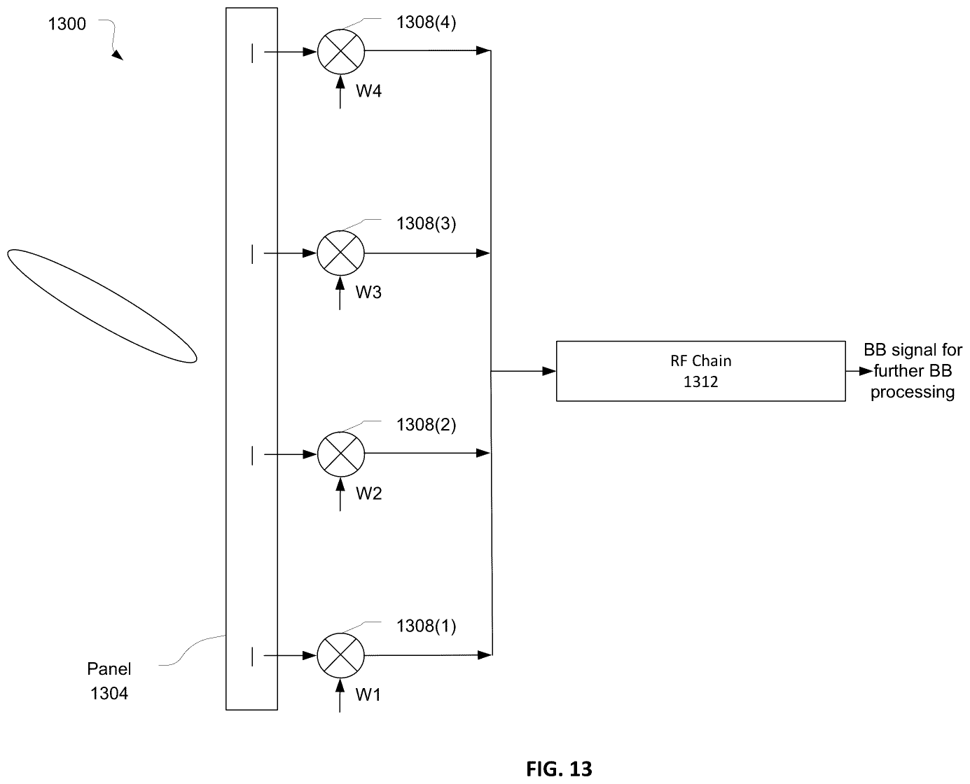

FIG. 13 illustrates receive components 1300 of the UE 1306, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1)-1308(4) may be coupled with a radio-frequency (RF) chain 1312. The RF chain 1312 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1308(1)-1308(4) to provide a receive beam at the antenna panel 1304. These BF weights may be determined based on the channel-based beamforming.

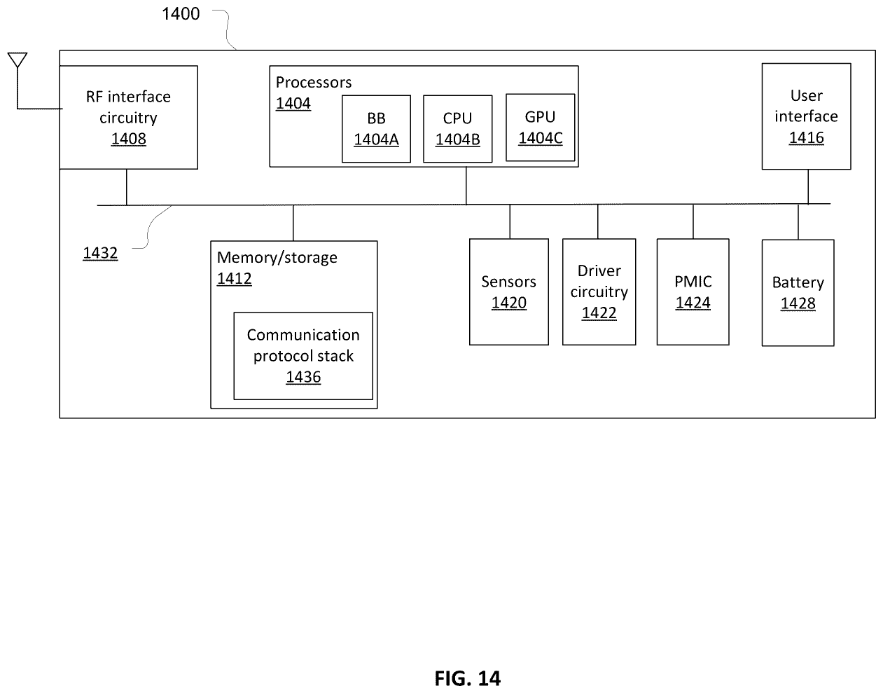

FIG. 14 illustrates a UE 1400, in accordance with some embodiments. The UE 1400 may be similar to and substantially interchangeable with UE 1306 of FIG. 13.

Similar to that described above with respect to UE 1400, the UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information 1424 from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1424 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1424.

In various embodiments, the RF interface circuitry 1408 may be configured to transmit/receive signals in a manner compatible with NR access technologies.

The antenna 1424 may include a number of antenna elements that each convert electrical signals into radio waves to travel through the air and to convert received radio waves into electrical signals. The antenna elements may be arranged into one or more antenna panels. The antenna 1424 may have antenna panels that are omnidirectional, directional, or a combination thereof to enable beamforming and multiple input, multiple output communications. The antenna 1424 may include microstrip antennas, printed antennas fabricated on the surface of one or more printed circuit boards, patch antennas, phased array antennas, etc. The antenna 1424 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC Idle state, where it disconnects from the network and does not perform operations such as channel quality feedback, handover, etc. The UE 1400 goes into a very low-power state, and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

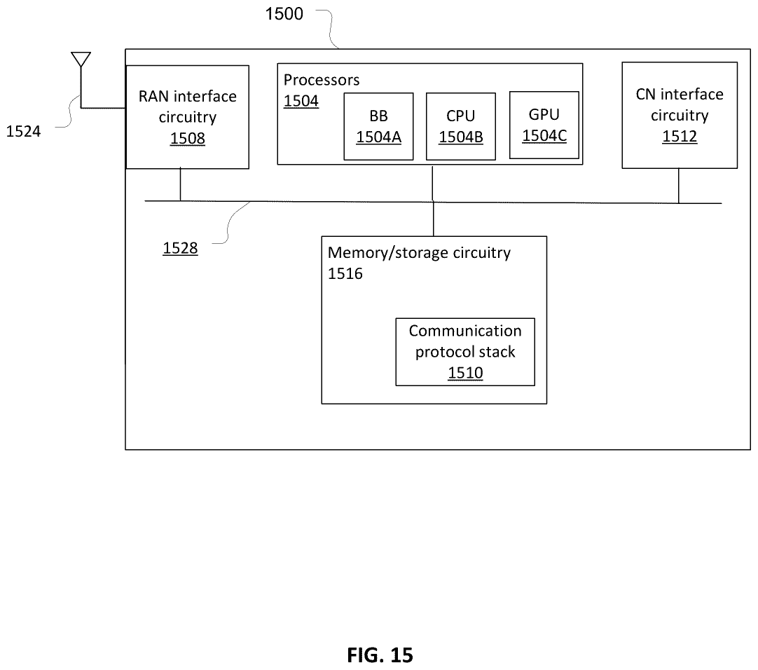

FIG. 15 illustrates a gNB 1500, in accordance with some embodiments. The gNB node 1500 may be similar to and substantially interchangeable with the base stations 154, 156 of FIG. 1.

The gNB 1500 may include processors 1504, RF interface circuitry 1508, core network (CN) interface circuitry 1512, and memory/storage circuitry 1516.

The components of the gNB 1500 may be coupled with various other components over one or more interconnects 1528.

The processors 1504, RF interface circuitry 1508, memory/storage circuitry 1516 (including communication protocol stack 1510), antenna 1524, and interconnects 1528 may be similar to like-named elements shown and described with respect to FIG. 13.

The CN interface circuitry 1512 may provide connectivity to a core network, for example, a 4^{th} Generation Core network (5GC) using a 4GC-compatible network interface protocol such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided
Example 1 can include a method performed by a user equipment (UE), the method comprising determining capability information associated with wake-up signal (WUS) monitoring, the capability information to include an indication that the UE supports WUS monitoring in a radio resource control (RRC) connected mode; transmitting, to a base station, an indication of the capability; performing, while in a sleep state in which transmitting and receiving by a main radio of the UE is suspended, WUS monitoring; transitioning from the sleep state to an awake state based on a trigger; and monitoring for a downlink (DL) transmission from the base station in the awake state.
Example 2 can include example 1, wherein the capability information further includes: a first switching gap value indicating a first time interval for the UE to transition from the sleep state to the awake state; or a second switching gap value indicating a second time interval for the UE to prepare for WUS monitoring after receipt of a corresponding WUS monitoring trigger.
Example 3 can include example 2, wherein the capability information includes both the first switching gap value and the second switching gap value as a pair.
Example 4 can include example 2, wherein the first switching gap value is based on a subcarrier spacing (SCS), and wherein the second switching gap value is based on the SCS.
Example 5 can include any of examples 1-4, wherein the capability information further includes a performance parameter associated with the WUS monitoring.
Example 6 can include any of example 1-5, wherein the capability information includes a first switching gap value indicating a first time interval for the UE to transition from the sleep state to the awake state when the sleep state is of a first type and a second switching gap value indicating a second time interval for the UE to transition from the sleep state to the awake state when the sleep state is of a second type.
Example 7 can include any of examples 1-6, wherein the method further includes: determining whether the first switching gap value is to be defined with respect to a start of the WUS or an end of the WUS; and determining the first switching gap value based on the determination of whether the first switching gap value is to be defined with respect to the start of the WUS or the end of the WUS.
Example 8 can include any of examples 1-7, further comprising: transitioning from the awake state to a sleep state via a downlink control information (DCI) transmission is used to transmit the trigger.
Example 9 can include any of examples 1-8, further comprising a network receiving a WUR performance parameter, wherein the WUR performance parameter is either a WUR sensitivity value used to achieve a performance target or a signal to interference noise ratio (SINR) value used to achieve the performance target.
Example 10 can include any of examples 1-9, wherein the WUR performance parameter is based on a WUR architecture and power consumption level.
Example 11 can include any of examples 1-10, wherein the UE is configured by the base station with the performance target.
Example 12 can include any of examples 1-11, further comprising transmitting a performance parameter corresponding to the performance target, based on time and frequency resources allocated for monitoring the WUS.
Example 13 can include any of examples 1-12, further comprising transmitting the capability to transition from the sleep state to the awake state based on the trigger, wherein the trigger is receiving a wake-up signal (WUS) or a passage of time in sleep state without detecting the WUS.
Example 14 can include any of examples 1-3, further comprising transmitting a capability to transition from the awake state to the sleep state based on an indication from a DCI transmission, a time-based trigger, a detection by the UE of a condition, or a UE triggered state transition.
Example 15 can include a method performed by a user equipment (UE), the method comprising: receiving a trigger to a state transition, wherein the state transition is from a sleep state to an awake state or is from the awake state to the sleep state, and wherein the UE is to transmit and receive by a main radio of the UE in the awake state and suspend transmitting and receiving by the main radio in the sleep state; transitioning from the sleep state to the awake state based on receiving the trigger, wherein the UE is to transmit to and receive from a base station while in the awake state; and monitoring for a downlink (DL) transmission from the base station in the awake state.
Example 16 can include example 15, wherein the trigger is receiving a wake-up signal (WUS) or a passage of time in the sleep state without detecting the WUS.
Example 17 can include a method performed by a user equipment (UE) the method comprising: receiving a trigger to transition from a sleep state to an awake state, wherein, based on the trigger, a main radio of the UE is to transmit or receive and a wake up receiver (WUR) of the UE is to simultaneously monitor for a wake signal (WUS); transitioning from the sleep state to the awake state based on receiving the trigger; monitoring, by the WUR of the UE, for the WUS based on being in the awake state; and performing, by the main radio of the UE, a transmission or a reception based on being in the awake state.
Example 18 can include example 17, wherein the trigger includes a UE need to transmit or receive to perform semi-statically configured downlink (DL) reception and uplink (UL) transmission.
Example 19 can include any of examples 17 or 18, wherein the semi-statically configured DL reception excludes PDCCH monitoring in some or all UE-specific search space sets.
Example 20 can include any of examples 17-20, wherein the trigger includes switching to the awake state after monitoring for the WUS for a pre-defined or configured time.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A user equipment (UE), comprising:
a processor; and
a computer-readable medium including instructions that, when executed by the processor, cause the processor to perform operations comprising:
determining capability information associated with wake-up signal (WUS) monitoring, the capability information to include an indication that the UE supports WUS monitoring in a radio resource control (RRC) connected mode;
transmitting, to a base station, an indication of the capability;
performing, while in a sleep state in which transmitting and receiving by a main radio of the UE is suspended, WUS monitoring;
transitioning from the sleep state to an awake state based on a trigger; and
monitoring for a downlink (DL) transmission from the base station in the awake state.

2. The UE of claim 1, wherein the capability information further includes:
a first switching gap value indicating a first time interval for the UE to transition from the sleep state to the awake state; or
a second switching gap value indicating a second time interval for the UE to prepare for WUS monitoring after receipt of a corresponding WUS monitoring trigger.

3. The UE of claim 2, wherein the capability information includes both the first switching gap value and the second switching gap value as a pair.

4. The UE of claim 2, wherein the first switching gap value is based on a subcarrier spacing (SCS), and wherein the second switching gap value is based on the SCS.

5. The UE of claim 1, wherein the capability information further includes a performance parameter associated with the WUS monitoring.

6. The UE of claim 1, wherein the capability information includes a first switching gap value indicating a first time interval for the UE to transition from the sleep state to the awake state when the sleep state is of a first type and a second switching gap value indicating a second time interval for the UE to transition from the sleep state to the awake state when the sleep state is of a second type.

7. The UE of claim 6, wherein the operations further comprise:
determining whether the first switching gap value is to be defined with respect to a start of the WUS or an end of the WUS; and
determining the first switching gap value based on the determination of whether the first switching gap value is to be defined with respect to the start of the WUS or the end of the WUS.

8. The UE of claim 6, wherein the operations further comprise:
transitioning from the awake state to a sleep state, wherein a downlink control information (DCI) transmission is used to trigger the transition.

9. The UE of claim 1, further comprising a network receiving a WUR performance parameter, wherein the WUR performance parameter is either a WUR sensitivity value used to achieve a performance target or a signal to interference noise ratio (SINR) value used to achieve the performance target.

10. The UE of claim 9, wherein the WUR performance parameter is based on a WUR architecture and power consumption level.

11. The UE of claim 9, wherein the UE is configured by the base station with the performance target.

12. The UE of claim 11, further comprising transmitting a performance parameter corresponding to the performance target, based on time and frequency resources allocated for monitoring the WUS.

13. The UE of claim 1, further comprising transmitting the capability to transition from the sleep state to the awake state based on the trigger, wherein the trigger is receiving a WUS or a passage of time in sleep state without detecting the WUS.

14. The UE of claim 1, further comprising transmitting a capability to transition from the awake state to the sleep state based on an indication from a DCI transmission, a time-based trigger, a detection by the UE of a condition, or a UE triggered state transition.

15. A method performed by a user equipment (UE), the method comprising:
receiving a trigger for a state transition, wherein the state transition is from a sleep state to an awake state or is from the awake state to the sleep state, and wherein the UE is to transmit and receive by a main radio of the UE in the awake state and suspend transmitting and receiving by the main radio in the sleep state;
transitioning from the sleep state to the awake state based on receiving the trigger, wherein the UE is to transmit to and receive from a base station while in the awake state; and
monitoring for a downlink (DL) transmission from the base station in the awake state.

16. The method of claim 15, wherein the trigger is receiving a wake-up signal (WUS) or a passage of time in the sleep state without detecting the WUS.

17. A non-transitory, computer-readable medium having stored thereon a sequence of instructions which, when executed, causes a processor to perform operations comprising:
receiving a trigger to transition from a sleep state to an awake state, wherein, based on the trigger, a main radio of a user equipment (UE) is to transmit or receive and a wake up receiver (WUR) of the UE is to simultaneously monitor for a wake signal (WUS);
transitioning from the sleep state to the awake state based on receiving the trigger;
monitoring, by the WUR of the UE, for the WUS based on being in the awake state; and
performing, by the main radio of the UE, a transmission or a reception based on being in the awake state.

18. The non-transitory, computer-readable medium of claim 17, wherein the trigger includes a UE need to transmit or receive to perform semi-statically configured downlink (DL) reception and uplink (UL) transmission.

19. The non-transitory, computer-readable medium of claim 18, wherein the semi-statically configured DL reception excludes physical downlink control channel (PDCCH) monitoring in some or all UE-specific search space sets.

20. The non-transitory, computer-readable medium of claim 17, wherein the trigger includes switching to the awake state after monitoring for the WUS for a pre-defined or configured time.
